(19) United States
(12) Patent Application Publication
(10) Pub. No.: US 2008/0299811 A1
(43) Pub. Date: Dec. 4, 2008

(54) Power inlets and power connectors

(76) Inventor: Paul F. Battista, Budd Lake, NJ (US)

Correspondence Address: Francis C. Hand, Esq.;c/o Carella, Byrne, Bain, Gilfillan, Cecchi,, Stewart & Olstein, 5 Becker Farm Road, Roseland, NJ, 07068, US

(21) Appl. No.: 11/807,810

(22) Filed: May 30, 2007

(51) Int. Cl. H01R 13/625

(52) U.S. Cl. 439/345

(57) ABSTRACT

In one embodiment, the power inlet has three terminals disposed in co-planar parallel alignment in a cavity of a housing of limited height as well as an asymmetrically located projection for polarization purposes. The power connector has three female contacts disposed in co-planar parallel alignment in a housing for mating with the terminals in the power inlet as well as an asymmetrically disposed groove for receiving the projection of the power inlet. A latching device has resilient arms that slide into the interior of the power inlet housing and lock at the ends in openings in the sides of the power inlet housing.

This invention relates to electrical power equipment and, particularly, to power inlets and power connectors.

As is know, various types of electrical power inlets and connectors have been used to connect electrically operated devices to a source of electricity. In particular, use has been made of appliance couplers as defined by the International Electrotechnical Commission (IEC) specification IEC 60320. These include two and three-conductor cord connectors and inlets of various current capacities and temperature ratings for the attaching of a mains power cord to a piece of equipment. Thus, a mains power cord may be connected with several different types of equipment without need for the mains power cord to be custom designed for a particular piece of equipment.

However, in cases where a device has a limited height of ⅝″ or a limited surface area for an AC inlet that requires AC current from a branch circuit, wall outlet or other primary source of AC power though a power cord, use cannot be made of an AC Inlet of standard size as currently specified in standards, such as IEC 60320, ANSI/UL 498, ANSI/NEMA WD6 or UL 1681.

In many cases, power connectors have latching devices to secure the connector in place on a power inlet of a device, for example, as described in U.S. Pat. Nos. 4,392,706; 4,526,431; 4,647,128 and 5,069,634. However, in the case of a device with a limited depth available behind the device, the use of a latching inlet with a shroud protruding outward from the inlet is not possible. Further, the use of a cable retaining clamp to lock a power connector to a power inlet requires a tool to tighten a screw attached to the retaining clamp which compresses the clamp around the power cord connector. Also, in order to remove the power cord connector from the inlet, a tool must be used to loosen the screw on the cable retaining clamp.

In a situation where there is a partially mated connection between a power cord connector and an inlet there would be exposed contacts inside the inlet which could possibly cause an electrical safety hazard where an arcing condition could possibly occur between contacts.

Accordingly, it is an object of the invention to provide an AC power inlet for use on a device having a limited height for receiving a power inlet.

It is another object of the invention to provide a power connector with a latching device that can be used in a limited space.

It is another object of the invention to be able to secure, latch or lock a power connector to a power inlet without the use of tools.

It is another object of the invention to be able to disconnect a latched or locked power connector from a power inlet without the use of tools.

It is another object of the invention to insure a full insertion of a power connector into a power inlet to assure that contacts are not exposed and are fully insulated by an insulating body of the connector.

Briefly, the invention provides a power inlet that is comprised of a thermoplastic housing of box-like shape that defines a cavity of rectangular cross-sectional shape; three terminals disposed in a co-planar parallel alignment in the cavity of the housing; and a projection on the housing that extends into the cavity in an asymmetric relation thereto.

The use of three terminals in co-planar parallel relation reduces the height required by the power inlet such that the power inlet can be used on devices that have a limited area or height, for example, ⅝ inch, for an inlet. Also, this allows use of an inlet with an on/off switch or an inlet with a fuse holder where use cannot otherwise be made of an AC inlet of standard size with an on/off switch or fuse holder.

The invention also provides a power cord connector that is comprised of a thermoplastic housing of box-like shape that defines a rectangular cross-sectional shape, three female contacts disposed in co-planar parallel alignment in the housing for receiving the terminals of a power inlet therein; and a groove in an exterior surface of the housing that is disposed in an asymmetric relation to the housing. As above, the female contacts are disposed in co-planar relation to reduce the height taken up by the connector.

The use of the asymmetrically disposed groove on the housing of the power cord connector allows the connector to be properly aligned with the asymmetric projection on the housing of the inlet to thereby provide for polarization.

The invention also provides a latching device for securing the connector to the inlet in a simple reliable manner without the use of tools. In this regard, each side wall of the housing of the power inlet is provided with an opening and the power cord connector is provided with a pair of resilient arms on opposite sides that are slidably received in the cavity of the housing of the power inlet. Each arm also has an outwardly directed end that is received in a respective opening of the housing of the power inlet in order to secure the power cord connector to the power inlet.

The latching of the power cord connector to the power inlet is achieved inside the power inlet contact cavity and, thus, solves the problem for the need of an additional shroud which would protrude outward from the face of the inlet thereby increasing the required depth behind the enclosure of a device employing the inlet.

Also, molding the latching arms into the housing of the power cord connector and the latching openings in the latching power inlet, eliminates the need for an additional cable retaining clamp in order to lock the power cord connector to the inlet.

Further, the latching arms are molded to the connector so as to be depressed by one hand to unlock the connector from the power inlet thereby allowing the connector to be disconnected from the power inlet.

Because no tools are required to remove the connector from the power inlet and only a fast and easy single handed press and pull motion is needed to unlock the connector from the inlet, the problem of how to quickly disconnect a power cord connector that is locked into a power inlet is solved.

To solve the problem of the possibility of a partially mated connection between the power cord connector and the inlet which would cause exposed contacts inside the inlet which could possibly cause an electrical safety hazard where an arcing condition could possibly occur between contacts, the latching arms of the power cord connector will only lock into the openings in the power inlet when the connector is fully inserted into the inlet. This assures that the contacts are not exposed and are fully insulated by the insulating housing of the connector.

The power inlet may be constructed to accommodate other devices or mountings as is conventional. For example, the power inlet may have an on/off switch or a filter case mounted on the housing or a fuse holder integral with the housing. Also, the power inlet may have a flange integral with the housing that extends laterally of the housing at an open end thereof for mounting purposes.

These and other objects and advantages of the invention will become more apparent from the following detailed description taken in conjunction with the accompanying drawings wherein:

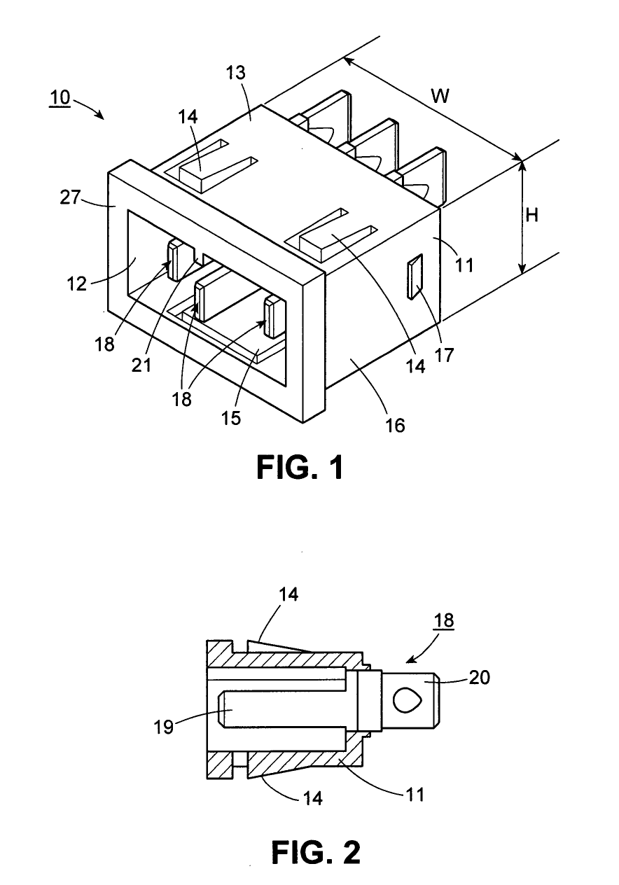

FIG. 1 illustrates a perspective view of a power inlet constructed in accordance with the invention;

FIG. 2 illustrates a cross-sectional view of the inlet of FIG. 1;

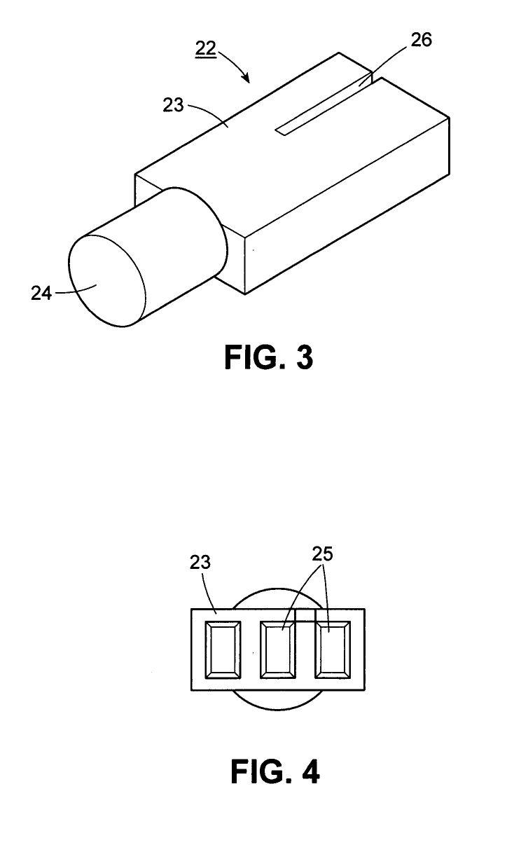

FIG. 3 illustrates a perspective view of a power connector constructed in accordance with the invention;

FIG. 4 illustrates a front view of the power connector of FIG. 3;

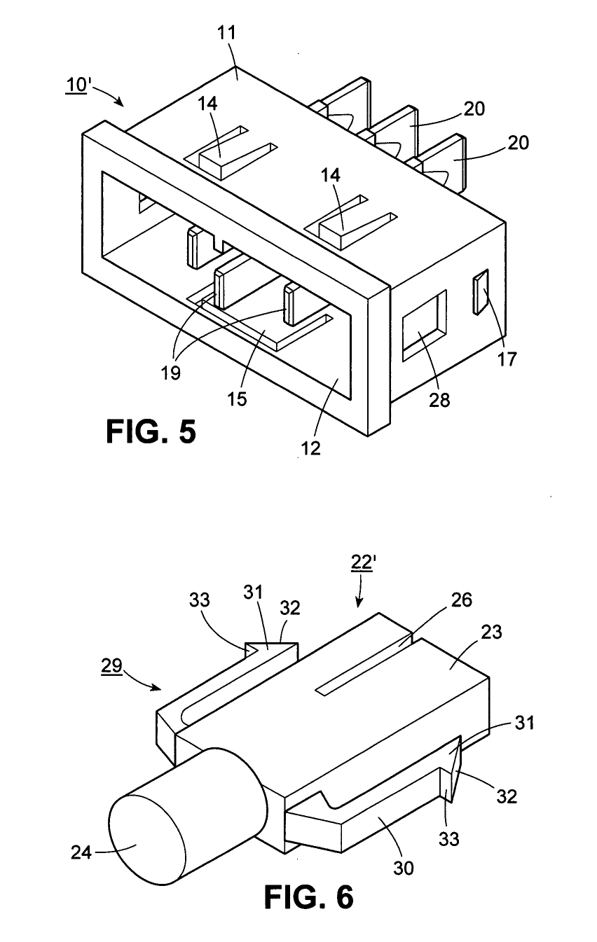

FIG. 5 illustrates a perspective view of a modified power inlet constructed to receive a latching device of a power connector in accordance with the invention;

FIG. 6 illustrates a perspective view of a power connector with a latching device constructed in accordance with the invention;

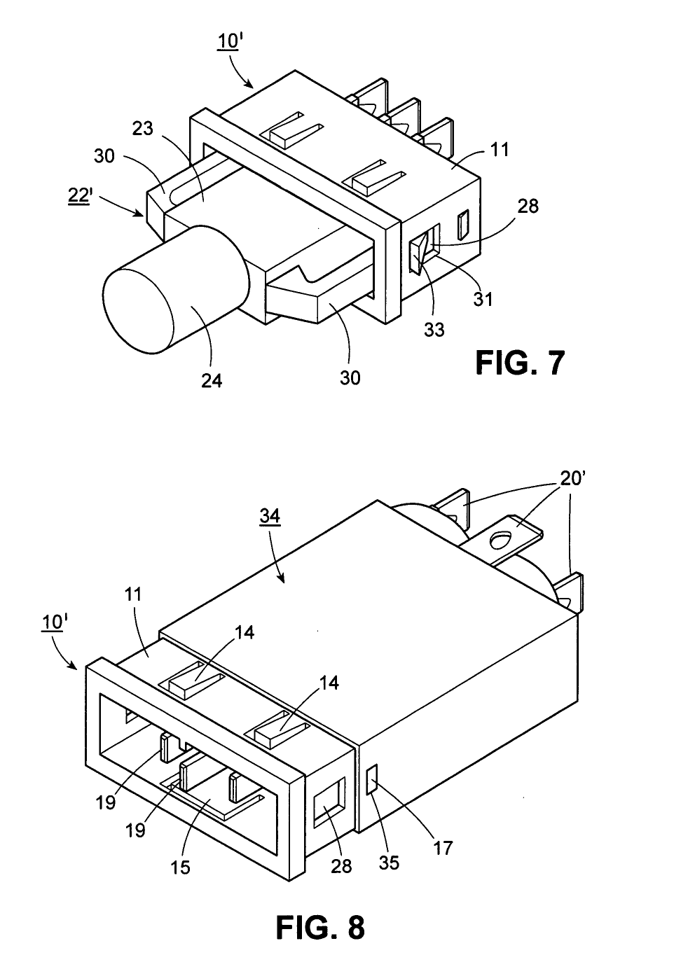

FIG. 7 illustrates a perspective view of the power inlet of FIG. 5 and the power connector of FIG. 6 fully mated together;

FIG. 8 illustrates a perspective view of a power inlet constructed with a filter housing in accordance with the invention;

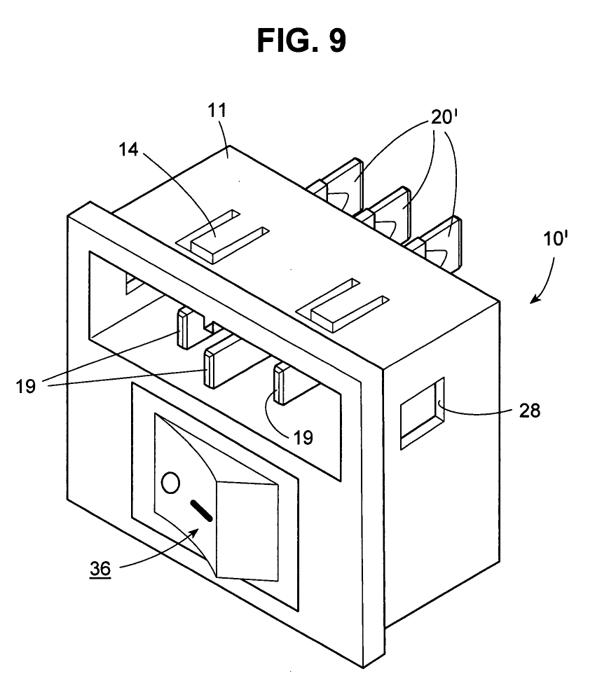

FIG. 9 illustrates a perspective view of a power inlet constructed with an on/off switch in accordance with the invention;

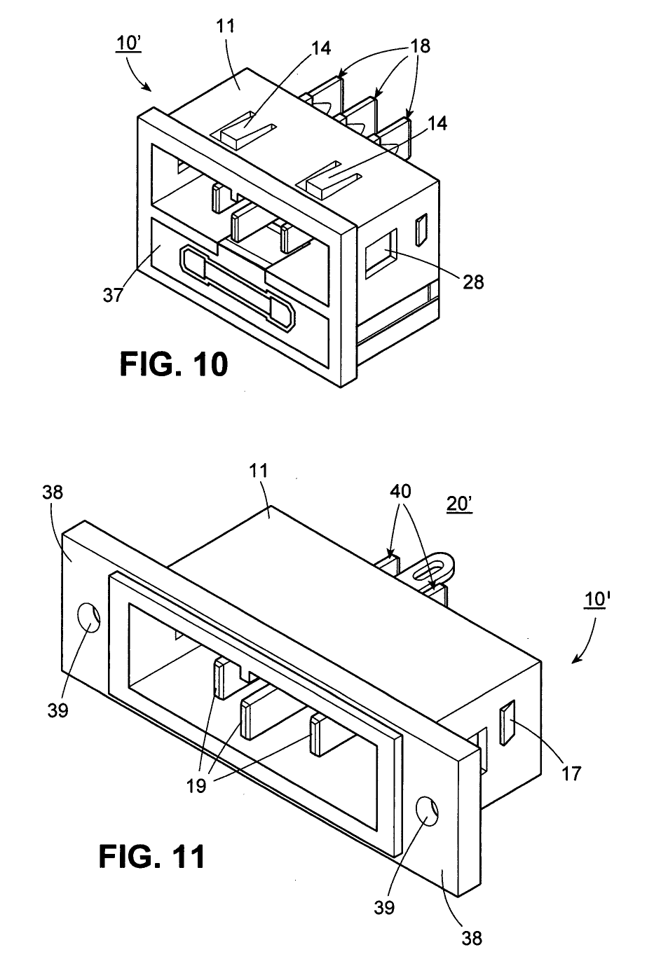

FIG. 10 illustrates a perspective view of a power inlet constructed with a fuse holder in accordance with the invention; and

FIG. 11 illustrates a perspective view of a power inlet with a mounting flange in accordance with the invention.

Referring to FIG. 1, the power inlet 10 has a housing 11 of box-like shape that defines a cavity 12 of rectangular cross-sectional shape. The housing 11 is made of a plastic material that is suitable for use in an electric power inlet and for molding purposes, for example the housing material can be, but is not limited to, thermoplastics or thermosetting polymers.

In addition, the top side 13 of the housing 11 has a air of integral tabs 14 that extend upwardly as indicated in FIG. 2 while the bottom side has an integral tab 15 that extends downwardly as illustrated in FIG. 2. The tabs 14, 15 serve to snap-fit the inlet 10 into a device, such as the back side wall of a piece of electrical equipment.

Each side wall 16 of the housing 11 has a optional integral tab 17 that extends outwardly (only one of which is shown) for receiving a filter housing (not shown) or the like.

Referring to FIGS. 1 and 2, the inlet 10 also has three terminals 18 that are disposed in co-planar parallel alignment within the cavity 12 of the housing 11 for conducting electrical current. Each terminal 18 includes a flat-bladed contact 19 that is disposed within the cavity 12 of the housing 11 and an apertured end 20 that is exposed to the rear of the housing 11. Typically, the housing 11 is molded about the three terminals 18.

Each terminal 18 is of one piece construction and is made of any suitable electrically-conductive metal, such as brass, and may or may not be plated with a material such as, but not limited to, nickel or tin.

Referring to FIG. 1, an elongated projection 21 in the form of a bar is integrally molded into the housing 11 to extend into the cavity 12 in an asymmetric relation. That is to say, the projection 21 is offset laterally from the center plane of the housing 11.

Referring to FIG. 3, the power cord connector 22 is constructed with a housing 23 of box-like shape that defines a rectangular cross-sectional shape. As illustrated, a strain relief 24 of conventional construction is connected with the housing 23. The housing 23 is made of a molded material such as, polyvinylchloride (PVC) but is not limited to this material.

The power cord connector 22 is molded onto cordage (not shown) of various wire gauges and jacket types which also may or may not include a power cord plug attached to the opposite end of the cordage.

Referring to FIG. 4, the housing 23 of the connector 22 is provided with three hollow female contacts 25 that are disposed in co-planar parallel alignment within the housing 23 for receiving the terminals 18 of the power inlet 10. The three female contacts 25 thus serve for a line, a neutral and a ground. The contacts 25 are metal and may or may not be plated with a material such as, but not limited to nickel or tin. Where the connector 22 is to receive an inlet with only two contacts 19, the middle contact 25 (ground) is excluded.

Referring to FIG. 3, the housing 23 of the connector 22 is provided with an elongated groove 26 in the exterior top surface that is of a size to slidably receive the elongated projection 21 of the power inlet 10 for polarization purposes.

The power inlet 10 and power connector 22 are constructed so that the housing 23 of the connector 22 can be slid into the cavity 12 of the inlet 10 in order to mate the terminals 18 of the inlet in the contacts 25 of the connector 22.

The inlet housing 11 has a limited height (H) of, for example 13.2 millimeters and a width (W) of 23.9 millimeters.

Referring to FIG. 1, the housing 11 may also be provided with an integral frame 27 of rectangular shape that extends outwardly of the housing 11 so as to abut against the wall of a device receiving the inlet 10.

Referring to FIG. 5, wherein like reference characters indicate like parts as above, the power inlet 10′ may be constructed to receive a latching device. In this respect, each of the opposite side walls 16 of the housing 11 is provided with a slot or opening 28 forwardly of the tab 17.

Referring to FIG. 6, wherein like reference characters indicate like parts as above, the power connector 22′ is provided with a latching device 29 for securing the connector 22′ to the inlet 10′ in a simple reliable manner. As indicated, the latching device 29 is formed of pair of resilient arms 30, each of which is located on an opposite side of the housing 23 of the connector 22′. Each arm 30 is of L-shape and is integrally molded with the housing 23. Each arm 30 extends in parallel spaced relation to the housing 23 and terminates in an outwardly directed end 31. As illustrated, each end 31 has a tapered forward surface 32 and a flat rear surface 33.

The connector 22′ is sized so that the housing 23 slides into the cavity 12 of the power inlet 10′ along with the arms 30 of the latching device 29. As the arms 30 move into the inlet 10′, the forward tapered surfaces 32 abut the frame 27 and are forced inwardly toward the housing 23 of the connector 22′.

Referring to FIG. 7, when the connector housing 23 is fully mated within the housing 11 of the inlet 10′, the ends 31 of the respective arms 30 are aligned with the openings 28 in the inlet housing 11. At this time, arms 30 are able to spring laterally outwardly so that the ends 31 of the arms 30 pass into and through the openings 28 in the housing 11. At this time, the flat surfaces 33 of the ends 31 of the arms 30 abut against a flat wall of the respective opening 28 thereby locking the connector 22′ in place within the inlet 10′.

When the connector 23 is fully mated in the inlet 10′, the arms 30 of the latching device 29 are exposed outside of the inlet 10′.

In order to disconnect the connector 22′ from the inlet 10′, the exposed portions of the respective arms 30 are pressed inwardly in a manual operation using one hand. The manual pressure applied should be sufficient to move the ends 31 of the arms out of the plane of the respective openings 28. This allows the connector to be manually slid out of the housing 11 of the inlet 10′.

Referring to FIG. 8, wherein like reference characters indicate like parts as above, a filter case 34, for example of metal, is snap-fitted onto the rear end of the inlet 10′. In this respect, the filter case 34 is provided with a small aperture 35 in each side wall so as to receive a tab 17 of the inlet housing 11.

Further, in this embodiment, terminals 20′ are provided at the rear of the filter case 34 that are separate from the flat-bladed contacts 19 and that connect with filtering components within the filter case 34. As illustrated, the terminals 20 extend from the filter case 34 in perpendicular relation to each other.

Referring to FIG. 9, wherein like reference characters indicate like parts as above, the power inlet 10′ may be constructed to have an on/off switch 36 in an otherwise conventional manner.

Referring to FIG. 10, wherein like reference characters indicate like parts as above, the power inlet 10′ may be constructed to have a fuse holder 37 in an otherwise conventional manner.

Referring to FIG. 11, wherein like reference characters indicate like parts as above, the power inlet 10′ may be provided with a flange 38 that is integral with the housing 11 and that extends laterally of the housing 11 on each of two sides for mounting purposes. As indicated, the flange 38 is provided with openings 39 for the passage of screws (not shown) for the mounting of the inlet 10′ on a device (not shown).

The rear of the power inlet 10′ may also have plastic barriers 40 that isolate the terminals 20′ as is known.

Various modifications may be made in the power inlet in accordance with the invention. For example, the terminals 18 may extend from the rear end of the inlet 10 in parallel as illustrated or in perpendicular relation. Alternatively, one terminal may extend horizontally while the other two terminals extend vertically from the housing 11.

The power inlets may be made with or without latching slots; with or without an earthing (grounding) contact; with or without a fuse holder; with or without a power on/off switch; and with or without an EMI/RFI filter.

The housing options may be, but are not limited to, snap-in type, or flange mount type. The terminal options may be, but are not limited to, 6.4 mm quick connect tabs, 4.8 mm quick connect tabs( as shown at 20 in FIG. 2), solder terminals or right angle PCB terminals.

The molded power cord connector may be made with or without latches; and with or without an earthing (grounding) contact.

The invention thus provides a power inlet that can be used on electrical equipment that has a limited surface area and/or a limited height, for example of ⅝ inch. Further, where the power inlet has an on/off switch or fuse holder incorporated therein, the overall height is less than the height of the standard power inlets with an on/off switch or fuse holder incorporated therein.

Further, the invention provides a latching device for securing a power connector with a power inlet that does not require tools and that allows for a simple manual release operation in order to disconnect the power connector from the power inlet.

The latching of the cord connector to the inlet prevents accidental or unintentional disconnection of the cord connector from the inlet which would result in a loss of power to the device.

Further, the technique of latching is achieved inside the cavity of the inlet as opposed to on a shroud protruding outward from the flange of the inlet thereby reducing the space required behind the device.

The invention further provides a latching that insures that a power connector is fully mated with a power inlet thereby assuring that contacts are not exposed and are fully insulated.

1. A power inlet comprising
a housing of box shape defining a cavity of rectangular cross-sectional shape;
three terminals disposed in co-planar parallel alignment in said cavity of said housing for conducting an electrical current, each of said terminals including a flat-bladed contact disposed within said cavity; and
a projection on said housing extending into said cavity in an asymmetric relation thereto.

2. The power inlet as set forth in claim 1 further comprising a pair of parallel tabs integral with and on one side of said housing, each said tab extending outwardly of said housing to snap-fit into a piece of electrical equipment.

3. The power inlet as set forth in claim 2 further comprising a third tab integral with and on a side of said housing opposite said pair of tabs, said third tab extending outwardly of said housing to snap-fit into a filter case.

4. The power inlet as set forth in claim 1 wherein each said terminal has an apertured end extending rearwardly of said housing.

5. The power inlet as set forth in claim 4 wherein each said apertured end of a respective one of said terminals extends from said housing in parallel to an adjacent terminal.

6. The power inlet as set forth in claim 4 wherein each said apertured end of a respective one of said terminals extends from said housing in perpendicular relation to an adjacent terminal.

7. The power inlet as set forth in claim 1 further comprising a filter case mounted on said housing, said filter case having a side wall with an aperture therein and said housing having a tab snap-fitted in said aperture.

8. The power inlet as set forth in claim 1 further comprising an on/off switch integral with said housing.

9. The power inlet as set forth in claim 1 further comprising a fuse holder integral with said housing.

10. The power inlet as set forth in claim 1 further comprising a flange integral with said housing and extending laterally of said housing at an open end thereof.

11. The power inlet as set forth in claim 1 wherein said projection is an elongated bar extending into said cavity of said housing to provide for polarization.

12. A power cord connector comprising
a housing of rectangular cross-sectional shape;
only three female contacts disposed in co-planar parallel alignment in said housing for receiving electrical terminals therein;
a groove in an exterior surface of said housing, said groove being disposed in an asymmetric relation to said housing; and
a latching device for securing said housing to a power inlet, said latching device including a pair of arms, each arm extending from an opposite side of said housing in parallel relation to the other of said pair of arms, each said arm having an end thereof spaced from said housing to allow resilient movement of said respective end towards and away from said housing.

13. (canceled)

14. In combination
a power inlet comprising a housing of box shape defining a cavity of rectangular cross-sectional shape, three terminals disposed in co-planar parallel alignment in said cavity of said housing for conducting an electrical current, and a projection on said housing extending into said cavity in an asymmetric relation thereto; and
a power cord connector secured to said power inlet, said connector comprising a housing of box shape defining a rectangular cross-sectional shape and slidably mounted in said cavity of said power inlet, only three female contacts disposed in parallel alignment in said housing slidably receiving said three electrical terminals, and an elongated groove in an exterior surface of said housing slidably receiving said projection of said power inlet.

15. The combination as set forth in claim 14 wherein said housing of said power inlet has a pair of openings in opposite sides thereof and said power cord connector has a pair of resilient arms on opposite sides thereof slidably received in said cavity of said housing of said power inlet, each said arm having an end received in a respective opening of said power inlet to secure said power cord connector to said power inlet.

16. In combination
a power inlet comprising a first housing of box shape defining a first cavity of rectangular cross-sectional shape, an array of three terminals disposed in co-planar parallel alignment in said first cavity of said housing for conducting an electrical current, and a pair of oppositely disposed openings in said first housing; and
a power cord connector secured to said power inlet, said connector comprising a second housing of box shape defining a rectangular cross-sectional shape and slidably mounted in said cavity of said power inlet, an array of only three female contacts disposed in said second housing and slidably receiving said terminals, and a pair of resilient arms on apposite sides of said housing slidably received in said cavity of said first housing of said power inlet, each said arm having an end received in a respective opening of said first housing to secure said power cord connector to said power inlet.

17. The combination as set forth in claim 16 wherein each said terminal of said power inlet includes a flat-bladed contact disposed within said first cavity and slidably received in a respective female contact, each said flat-bladed contact having an apertured end extending rearwardly of said first housing.

18. The combination as set forth in claim 16 further comprising a pair of parallel tabs integral with and on one side of said first housing, each said tab extending outwardly of said first housing.

19. The combination as set forth in claim 16 said first inlet housing has a limited height (H) of 13.2 millimeters and a width (W) of 23.9 millimeters.

20. A power inlet as set forth in claim 1 wherein said inlet housing has a limited height (H) of 13.2 millimeters and a width (W) of 23.9 millimeters.
